(19) United States
(12) Patent Application Publication
(10) Pub. No.: US 2002/0118366 A1
(43) Pub. Date: Aug. 29, 2002

(54) Optical remote measurement assembly

(75) Inventor: Edward K. Baldwin, Westborough, MA (US)

Correspondence Address: Pandiscio & Pandiscio, 470 Totten Pond Road, Waltham, MA, 02451, US

(73) Assignee: Thermo Electron Corporation

(21) Appl. No.: 09/989,078

(22) Filed: Nov. 21, 2001

Related U.S. Application Data
(60) Provisional application No. 60/271,924, filed on Feb. 27, 2001.

(51) Int. Cl. G01N 21/55

(52) U.S. Cl. 356/446

(57) ABSTRACT

An optical measurement assembly includes a processor for providing a light source, for receiving light from a sample, and for analyzing the received light for detecting and measuring a target substance, and an optical head including a housing, a source light mirror mounted in the housing for directing a light beam onto the sample, the beam having a central axis extending from the source light mirror, a collector mirror mounted in the housing and having a central axis coinciding with the light beam central axis, and configured to receive light reflected from the sample, and a return mirror disposed in the housing for receiving light from the collector mirror. A source light guide extends from the processor light source to adjacent the optical head source light mirror, and a return light guide extends from adjacent the optical head return mirror to the light receiving means in the processor.

### CROSS-REFERENCE TO RELATED APPLICATION

This application claims the benefit of provisional patent application S.No. 60/271,924, filed Feb. 27, 2001.

### BACKGROUND OF THE INVENTION

1. Field of the Invention

The invention relates to optical measurement assemblies and is directed more particularly to an optical measurement assembly wherein electronics components are remote from optical components, such that the optical components may be disposed in confined and/or hazardous environments while the electronics components remain remote therefrom.

2. Description of the Prior Art

It is known to use optical measurement systems for detecting and measuring the presence of, and parameters of, a target substance in or on a substrate.

For example, in U.S. Pat. No. 4,097,743, issued Jun. 27, 1978, to Roger E. Carlson, there is shown and described an optical device for measuring the moisture content of a sample. The device includes a light source, mirrors and lenses to direct the light onto the sample, a collector mirror to focus light reflected from the sample onto a detector, and associated electronics to analyze the light and determine the moisture content. In this and similar systems, the electronic and optical components are mounted in the same housing. The size of the components restricts the use of the system in confined spaces. Further, in view of the presence of the electronic components, the system cannot be used in hot or hazardous areas.

In U.S. Pat. No. 6,075,612, issued Jun. 13, 2000 to Michael J. Mandella et al, there is shown and described an optical device for detecting and measuring thin films on a substrate. The device includes a light source, an input optical fiber for carrying light from the source, a first mirror for directing light from the input optical fiber onto a substrate. The light is reflected off the substrate, and any film thereon, and back to a second mirror which reflects the light into an output optical fiber which, in turn, carries the light to an analyzer for determining the presence of the thin film, and desired characteristics of the film, such as thickness and composition thereof.

In U.S. Pat. No. 5,841,546, issued Nov. 24, 1998 to Robert M. Carangelo et al, there is shown and described a similar system for analyzing a surface to be painted, such as the surface of an airliner. The analyzer portion of the system is disposed on a ground-based vehicle and the optical scanning head is disposed at a remote location, typically on the end of an elongated gantry, mounted on the vehicle, for scanning an elevated aircraft surface.

In both of the '612 and '546 systems, the offset between the first and second mirrors in an optical head requires that the distance between the first mirror, for directing light onto the target, and the target itself be substantially constant. That is, the distance between the target and the first mirror must remain essentially constant for the reflected light to appropriately engage the second mirror. In many instances, maintaining a given distance between the optical head and sample is problematic, particularly when samples to be inspected are of varying size and configuration.

There is a need for an optical measurement assembly in which the electronics components are remote from the optical components and in which the distance between the target and the mirror which directs light onto the target is variable. One application where such an assembly is needed is in the measurement of coatings on pharmaceutical tablets

Pharmaceutical tablets are generally coated. The coatings have a variety of functions, including controlling the release of active ingredients, and improving swallowing properties, palatability, and shelf life. The coatings work as desired only when applied with sufficient thickness, uniformity, and other properties.

Pharmaceutical tablets typically are coated in pan coaters. These machines are similar to large industrial clothes dryers, with a coating device, such as a spray bar inserted into the coater opening. In operation, the tablets to be coated are placed inside a rotating drum. The coating, maintained in liquid solution or suspension, is applied to the tablets. Once a sufficient layer thickness is applied, the spray is turned off, and the coating is dried by air blowing through the dryer. This cycle may be repeated many times to provide a high quality, uniform coating.

The coating must be applied in many thin layers. To maintain product quality, each layer must be dried to a specified level, and the total coating thickness must reach a specified level. To insure this, coaters typically over-dry each layer, and over-coat the entire tablet. Patents on coaters include U.S. Pat. No. 3,601,086; U.S. Pat. No. 3,834,347; U.S. Pat. No. 4,639,383; and U.S. Pat. No. 4,543,906.

There is thus a further need for reliable on-line measurements of moisture and coating thickness in a pharmaceutical tablet coater. Such a moisture measurement allows tablet coaters to stop drying when the specified moisture is reached, rather than over-drying, and improves quality and reduces production cycle times, improving productivity. Similarly, a coating thickness measurement allows coating to a target, rather than over-coating.

### SUMMARY OF THE INVENTION

An object of the invention is to provide an optical remote measurement assembly in which the optics are removed from the electronics, such that the optics portion of the assembly is of a size adapted to be accepted by confined spaces, and the optics portion may be placed in spaces not suitable for electronics by reason of high temperature or hazardous atmosphere.

A further object of the invention is to provide such an assembly in which the distance between the optical scanning head and the target may be varied without affecting the efficiency of the assembly.

A still further object of the invention is to provide such an assembly for use with pharmaceutical tablet coating machines.

With the above and other objects in view, as will hereinafter appear, a feature of the present invention is the provision of an optical measurement assembly comprising a processor having means for providing a light source, means for receiving light from a sample, and analyzer means for analyzing the received light for detecting and measuring parameters of a target substance, and an optical head comprising a housing, a source light mirror mounted in the housing for directing a light beam onto the sample, the beam having a central axis extending from the source light mirror, a window mounted in the housing permitting light to pass therethrough, a collector mirror mounted in the housing and having a central axis coinciding with the light beam central axis, and configured to receive light reflected from the sample, and a return mirror disposed in the housing for receiving light from the collector mirror. A source light guide extends from the processor light source to adjacent the optical head source light mirror, and a return light guide extends from adjacent the optical head return mirror to the light receiving means.

In accordance with a further feature of the invention, there is provided an optical measurement assembly for use with a pharmaceutical tablet coating machine comprising a rotating drum disposed in a coater housing, and a coating device adapted to apply coating material onto tablets disposed in the drum, the coater housing including means for circulating air for drying the coating material applied to the tablets, and the measurement assembly being adapted to measure moisture in the coating and coating thickness. The measurement assembly comprises a processor for disposition outside of the coating machine housing and having means for providing a light source, means for receiving light from the coated tablets, and analyzer means for analyzing the received light for detecting and measuring coating moisture and thickness, and an optical head comprising an optical head housing for disposition in the drum, a source light mirror mounted in the optical head housing for directing a light beam onto the tablets in the drum, the beam having a central axis extending from the source light mirror, a window mounted in the optical head housing permitting light to pass therethrough, a collector mirror mounted in the optical head housing and having a central axis coinciding with the light beam central axis, and configured to receive light reflected from the tablets, a return mirror disposed in the optical head housing for receiving light from the collector mirror, a source light guide extending from the processor light source to adjacent the optical head source light mirror, and a return light guide extending from adjacent the optical head return mirror to the light receiving means.

The above and other features of the invention, including various novel details of construction and combinations of parts, will now be more particularly described with reference to the accompanying drawings and pointed out in the claims. It will be understood that the particular devices embodying the invention are shown by way of illustration only and not as limitations of the invention. The principles and features of this invention may be employed in various and numerous embodiments without departing from the scope of the invention.

### BRIEF DESCRIPTION OF THE DRAWINGS

Reference is made to the accompanying drawings in which are shown illustrative embodiments of the invention, from which its novel features and advantages will be apparent.

In the drawings:

FIG. 1 is a diagrammatic illustration of one form of optical remote measurement assembly showing an embodiment of the invention; and

FIG. 2 is a diagrammatic illustration of a measurement assembly, as shown in FIG. 1, in combination with a pharmaceutical tablet coating machine.

### DESCRIPTION OF THE PREFERRED EMBODIMENT

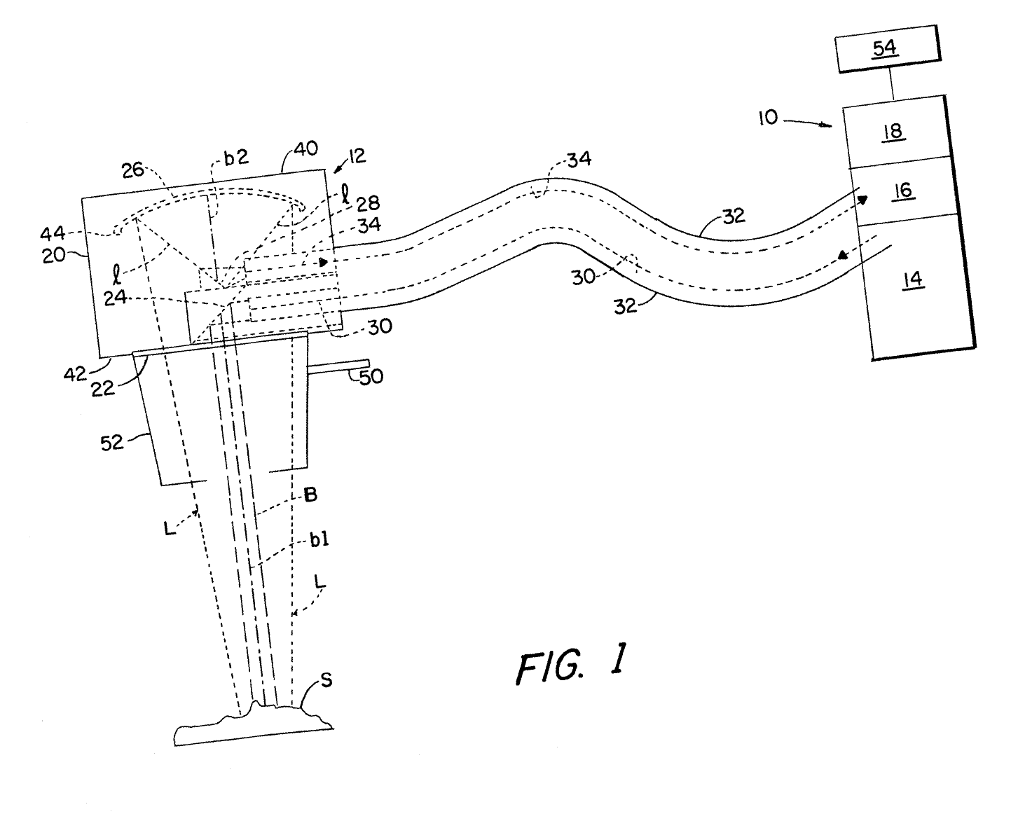

Referring to FIG. 1, it will be seen that the optical measurement assembly includes a processor 10 and an optical head 12.

The processor 10 includes a light source 14, means 16 for receiving light, and analyzer means 18 for analyzing received light, all shown diagrammatically in FIG. 1. The processor 10 is known in the art. An example of such processors is known as “Quadra-Beam 6600”, produced by Thermo Moisture Systems of Chelmsford, Mass. Such a processor provides instantaneous and continuous information on the content of key product constituents during production, and makes the information immediately available to an operator or an automatic control system, permitting immediate production line adjustments, which, in turn, allow for improved product consistency and quality.

The analyzer 18, light source 14, and receiver 16 preferably are suitable for near infrared (NIR) light. Molecular bonds, such as oxygen-hydrogen in water and carbon-hydrogen in organics, absorb near infrared light at well-defined wavelengths specific to the type of bond. The amount of NIR reflection at a given wavelength is inversely proportional to the content of molecules with that particular molecular bond. The analyzer computes the content of the constituents, such as moisture, from the NIR reflection at one or more wavelengths, one of which is specific to the constituent.

The optical head 12 includes a housing 20 having a window 22 therein, the window 22 being adapted to permit light to pass therethrough. The optical head 12, being devoid of electronics components, can be configured in a small size, such as 6″×6″×4″, or thereabouts. Mounted in the housing 20 are (i) a source light mirror 24 for directing a light beam B from a source light guide 30 onto a sample S, the beam B having a central axis b1 extending from the source light mirror 24, (ii) a collector mirror 26 having a central axis b2 coinciding with the light beam central axis b1, and configured to receive light L reflected from the sample S. and (iii) a return mirror 28 for receiving light 1 from the collector mirror 26, and launching the light 1 into the return light guide 34.

The source light guide 30 is disposed in a light guide conduit 32 and extends from the processor light source 14 to adjacent the source light mirror 24. Similarly, the return light guide 34 is disposed in the light guide conduit 32 and extends from adjacent the return mirror 28 to the light receiving means 16. The light guides 30, 34 preferably are fiber bundles or liquid-filled light guides. The collector mirror 26 and the return light guide 34 are optically matched such that light captured is efficiently coupled into the light guide 34 and carried to the analyzer 18. Similarly, the source light guide 30 efficiently collects light from the light source 14, maximizing the amount of light reaching the sample S. The light guides 30, 34 are of a diameter of more than one millimeter and are provided with large numerical apertures (>0.5) to effect the above-noted efficiencies.

Optical fibers accept light coming from inside an angle, known as an “acceptance angle”, which is measured from the axis of the optical fiber. The “numerical aperture” (N.A.) is defined as the sine of the acceptance angle. The presence of a large N.A. indicates that the optical fiber is adapted to accept light from a wide range of angles. In the present invention, the light guides 30, 34 exhibit a 310 degree acceptance angle and therefore an N.A. of 0.52. This allows the return light guide 34 to capture light from the entire collector mirror 26.

The collector mirror 26 is disposed proximate a first wall 40 of the housing 20, and the window 22 is disposed proximate an opposite wall 42 of the housing 20, with the source light mirror 24 and the return mirror 28 therebetween. Thus, the light L reflected from the sample S in part encounters support structure for the mirrors 24, 28, the light guides 30, 34, and the mirror 24 itself. However, the light L in greater part passes around the mirrors 24, 28, and light guides 30, 34 and reaches the collector mirror 26 from whence it is focused onto the return light guide 34 via the return mirror 28.

The collector mirror 26 captures light over a large solid, or three dimensional, angle. A hypothetical extension of a periphery 44 of the collector mirror 26 extended to the opposite wall 42 of the housing 20 defines a volume in which both the source light mirror 24 and the return mirror 28 are disposed. The large collector mirror 26 captures sufficient diffusely reflected light to make diffuse reflectance measurements readily attainable. The arrangement of the collector mirror 26 puts the optical object plane far from the optical head 12, with a large depth field. In one embodiment of the invention, the object plane is located 10″from the optical head, and the depth of field is approximately 8″. Because the optical axes b1 and b2 are coincident, and the depth of field is large, the distance between the optical head 12 and the sample S can be varied significantly without adversely affecting the accuracy and reliability of the system.

Inasmuch as there are no electronics in the optical head 12, the optical head may be used in environments too hot for an analyzer, such as the interiors of ovens and dryers. The optical head creates no fire or explosive hazards and may, therefore, be used in hazardous atmosphere environments. In addition, the small size of the optical head permits its usage in relatively small places which could not accept a processor (typically, 8″×7″×14″).

The processor 10 and optical head 12 may be separated by distances of 3,220 feet and more if the light guides consist of suitable glass fiber bundles. Performance of the system does not appear to be affected by the length of the light guides 30, 34 up to 3,220 feet. Inasmuch as there is no diminution of performance at that distance, it appears that much longer distances would be equally acceptable.

As shown in FIG. 1, a protective hood 52 preferably is mounted on the housing 20, around the window 22, and extending toward the sample S. The hood 52 shields the window from ambient light. In addition, the hood 52 may be provided with structure 50 for directing the flow of clean dry air to maintain the window 22 clear and free from particulate matter.

In operation, the light source 14 provides light energy to the source light guide 30, which conducts the light to the source light mirror 24, which directs the light through the window 22, as light beam B, to the sample S, which can be disposed on a conveyor belt (not shown), or the like. Light L reflected from the sample S passes through the window 22 to the collector mirror 26 which reflects the light 1 along the axis b2, which is coincident with the axis b1 of the beam B. The return mirror 28 directs the light 1 received from the collector mirror 26 to the return light guide 34 which conveys the light to the means 16 for receiving light, from whence the light enters the analyzer means 18. The analyzer means 18 typically is in communication with an automatic system 54, such as a display or a visual and/or audio alarm means, or the like.

Thus, the presence of a target substance in or on the sample S is determined, along with whatever additional parameters are desired, such as thickness of a layer and/or the amount of a target substance, such as the amount of moisture and/or the amount of a chemical or mineral substance.

As noted above, the optical head 12, without electronics components, is small enough to be placed in small compartments and can be used in hot and/or hazardous areas without danger of explosion or harm to electronics.

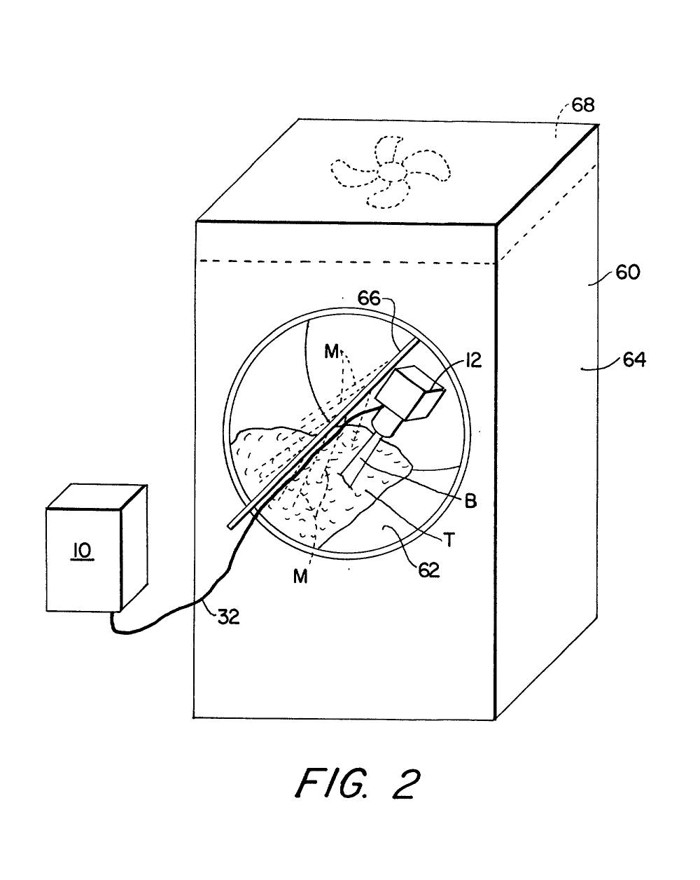

Referring to FIG. 2, it will be seen that in one application of the invention described hereinabove and shown in FIG. 1, the assembly is used in conjunction with a pharmaceutical tablet coating machine 60.

The tablet coating machine 60 includes a rotating drum 62 disposed in a housing 64, and a coating means for applying selected coatings to the tablets in the drum. For example, a spray bar 66 may be disposed in the drum 62 and adapted to direct spray coating material M onto tablets T disposed in the drum. Within the housing 64 is mounted an air circulation and drying means 68 for drying the coating material on the tablets.

The processor 10 is disposed remotely from the coating machine housing 64. The optical head 12 preferably is mounted on the spray bar 66 so as to be in position to direct a light beam B onto the tablets T in the drum 62.

The light guide conduit 32, housing the source light guide and return light guide, extends from the processor 10 to the optical head 12.

Once a sufficient layer thickness is applied, the coating application is turned off, and the coating is dried by air blowing through the dryer 68. This cycle may be repeated up to several hundred times to provide a high quality, uniform coating. Like paint, the coating must be applied in many thin layers. The small size of the optical head 12 allows installation in the drum 62 without significant disturbance of the dryer air flow. The air flow patterns are critical to maintaining uniform drying. A standard NIR sensor is too large, and affects the air flow. Because the optical head 12 contains no electronics, it can function in hot dryer environments. The moisture measurement allows tablet coaters to stop drying when the specified moisture is reached, rather than over-drying. This improves quality and reduces production cycle times, improving productivity. Similarly, a coating thickness measurement allows coating to a target, rather than over-coating. The remote measurement assembly provides real-time measurements of both moisture and coat thickness.

It is to be understood that the present invention is by no means limited to the particular construction herein disclosed and/or shown in the drawings, but also comprises any modification or equivalent within the scope of the claims.

What is claimed is:

1. An optical measurement assembly comprising:
a processor having means for providing a light source, means for receiving light from a sample, and analyzer means for analyzing the received light for detecting and measuring a target parameter;
an optical head comprising a housing, a source light mirror mounted in said housing for directing a light beam onto the sample, the beam having a central axis extending from said source light mirror, a window mounted in said housing permitting light to pass therethrough, a collector mirror mounted in said housing and having a central axis coinciding with the light beam central axis, and configured to receive light reflected from the sample, a return mirror disposed in said housing for receiving light from said collector mirror;
a source light guide extending from the processor light source to adjacent said optical head source light mirror; and
a return light guide extending from adjacent said optical head return mirror to said light receiving means.

2. The assembly in accordance with claim 1 wherein said analyzer means is adapted to communicate the target parameter to a selected one of an operator and an automatic system.

3. The assembly in accordance with claim 1 wherein the light beam which said source light mirror directs onto the sample is directed to said source light mirror by said source light guide, and the light which said return mirror receives from said collector mirror is directed to said light receiving means by said return light guide.

4. The assembly in accordance with claim 1 wherein said processor is spaced from said optical head.

5. The assembly in accordance with claim 1 wherein said collector mirror is disposed proximate a first wall of said housing, and said window is disposed proximate an opposite wall of said housing, and said source light mirror and said return mirror are disposed between said collector mirror and said window.

6. The assembly in accordance with claim 1 wherein said light guides are each a selected one of a (i) fiber bundle and (ii) liquid-filled guide.

7. The assembly in accordance with claim 1 wherein said light guides are of a diameter of more than one millimeter.

8. The assembly in accordance with claim 7 wherein at least said return light guide exhibits a numerical aperture of greater than 0.50.

9. The assembly in accordance with claim 1 wherein the analyzer means comprises a near infrared analyzer.

10. An optical measurement assembly for use with a pharmaceutical tablet coating machine comprising a rotating drum disposed in a housing, and a coating means adapted to apply coating material onto tablets disposed in the drum, the coating machine housing including means for circulating air for drying the coating material applied to the tablets, the measurement assembly being adapted to measure at least one of moisture in the tablet coating and coating thickness, the measurement assembly comprising:
a processor for disposition outside of the coating machine housing and having means for providing a light source, means for receiving light from the coated tablets, and analyzer means for analyzing the received light for detecting and measuring the at least one of coating moisture and thickness;
an optical head comprising an optical head housing for disposition in the drum, a source light mirror mounted in said optical head housing for directing a light beam onto the tablets in the drum, the beam having a central axis extending from said source light mirror, a window mounted in said optical head housing permitting light to pass therethrough, a collector mirror mounted in said optical head housing and having a central axis coinciding with the light beam central axis, and configured to receive light reflected from the tablets, a return mirror disposed in said optical head housing for receiving light from said collector mirror;
a source light guide extending from the processor light source to adjacent said optical head source light mirror; and
a return light guide extending from adjacent said optical head return mirror to said light receiving means.

11. The assembly in accordance with claim 10 wherein said analyzer means is adapted to communicate the tablet coating moisture and thickness to a selected one of an operator and an automatic system.

12. The assembly in accordance with claim 10 wherein the light beam which said source light mirror directs onto the tablets is directed to said source light mirror by said source light guide, and the light which said return mirror receives from said collector mirror is directed to said light receiving means by said return light guide.

13. The assembly in accordance with claim 10 wherein said processor is spaced from an interior of said tablet coating machine.

14. The assembly in accordance with claim 10 wherein said collector mirror is disposed proximate a first wall of said optical head housing, and said window is disposed proximate an opposite wall of said optical head housing, and said source light mirror and said return mirror are disposed between said collector mirror and said window.

15. The assembly in accordance with claim 10 wherein said light guides are of a diameter of more than one millimeter.

16. The assembly in accordance with claim 15 wherein at least said return light guide exhibits a numerical aperture of greater than 0.50.

17. The assembly in accordance with claim 10 wherein the analyzer means comprises a near infrared analyzer.

18. The assembly in accordance with claim 10 wherein said light guides are each a selected one of (i) fiber bundles and (ii) liquid-filled guides.

19. The assembly in accordance with claim 10 wherein said coating means comprises a spray bar disposed in the drum and adapted to spray the coating material onto the tablets disposed in the drum.
